(19) United States
(12) Patent Application Publication
(10) Pub. No.: US 2019/0156351 A1
(43) Pub. Date: May 23, 2019

(54) BRAND FOLLOWER TRACKING USING SOCIAL MEDIA DATA

(71) Applicant: INTERNATIONAL BUSINESS MACHINES CORPORATION, Armonk, NY (US)

(72) Inventors: Rama Kalyani T. Akkiraju, Cupertino, CA (US); Pierre-Hadrien Arnoux, New York, NY (US); Neil H. Boyette, Oregon City, OR (US); Haibin Liu, San Jose, CA (US); Jalal Mahmud, San Jose, CA (US); Vibha S. Sinha, Santa Clara, CA (US); Anbang Xu, San Jose, CA (US)

(21) Appl. No.: 15/817,773

(22) Filed: Nov. 20, 2017

(51) Int. Cl. G06Q 30/02; G06Q 50/00

(52) U.S. Cl. CPC G06Q 30/0201; G06Q 30/0269; G06Q 50/01

(57) ABSTRACT

Tracking of brand followers utilizing social media history and generation of directed advertising. A computing device receives a brand for market analysis, the brand having a brand account on a social media platform. Social media history is received regarding social media habits of social media users. A distribution of brand followers is determined among social media users following the brand account. One or more clusters are generated for viewing market segmentation regarding the brand for market analysis. Brand data is received regarding a plurality of brands having brand accounts on the social media platform, follower profiles for brand followers of the plurality of brand accounts, and social media information for the followers of the plurality of brand accounts. An influencer analysis is generated. Historical follower profiles are received. A historical distribution analysis is generated. A market analysis is generated. Directed advertising is generated based upon the market analysis.

### BACKGROUND

The present invention relates generally to the field of social media, and more particularly to social media listening and tracking of brand followers via utilization of social media data.

### BRIEF SUMMARY

Embodiments of the present invention disclose a method, system, and computer program product for tracking brand followers utilizing social media history and generating directed advertising. A computing device receives a brand for market analysis, the brand having a brand account on a social media platform. The computing device receives social media history regarding social media habits of social media users of the social media platform, the social media habits obtained from the social media users. The computing device determines a distribution of brand followers among social media users following the brand account on the social media platform based upon the social media habits of social media users from the social media users. The computing device generates one or more clusters for viewing market segmentation regarding the brand for market analysis, the one or more clusters generated by utilization of the social media habits of social media users from social media users. The computing device receives brand data regarding a plurality of brands having brand accounts on the social media platform, follower profiles for brand followers of the plurality of brand accounts, and social media information for the followers of the plurality of brand accounts. The computing device generates an influencer analysis for the plurality of brand accounts, the influencer analysis based upon the brand data regarding the plurality of brands, follower profiles, and the social media information for the followers of the plurality of brand accounts. The computing device receives a plurality of historical follower profiles for followers of the plurality of brand accounts, the historical follower profiles tracked according to a periodic basis. A historical distribution analysis is generated of each historical follower profile for a plurality of periods according to the periodic basis. The computing device receives a second brand for market analysis, the second brand for market analysis having a second brand account on the social media platform. The computing device determines a second distribution of second brand followers for social media users following the second brand account on the social media platform based upon the social media habits of social media users from social media users. A market analysis is generated for the brand for market analysis utilizing the distribution of brand followers, the one or more clusters for viewing market segmentation, the influencer analysis, the historical distribution analysis, or the second distribution of second brand followers. Directed advertising is generated for transmission to the social media users based upon the market analysis.

### BRIEF DESCRIPTION OF THE DRAWINGS

FIG. 1 is a functional block diagram illustrating an environment for tracking of brand followers via utilization of social media data, in accordance with an embodiment of the present invention.

FIGS. 2A, 2B, and 2C are a flowchart depicting operation steps that a hardware component, multiple hardware components, and/or a hardware appliance may execute, in accordance with an embodiment of the invention.

FIG. 3 depicts a block diagram of components of brand manager access module, brand follower analyzer, social media database, social media user, and social media platform of FIG. 1, in accordance with an embodiment of the present invention.

FIG. 4 depicts a cloud computing environment, in accordance with an embodiment of the present invention.

FIG. 5 depicts abstraction model layers, in accordance with an embodiment of the present invention.

### DETAILED DESCRIPTION

Social media has become an important platform for business and brands. Many brands leverage social media platforms for different purposes. Social media platforms may be used, for example, to promote products to the public, circulate incentive advertising, broadcast marketing messages for public relations purposes, etc. In particular, individuals who follow brand accounts in social media are assumed to have interest in the brands themselves, and these individuals may be targeted as very likely consumers. Presented are a method, a system, and a computer program product for brand follower tracking and directed advertising generation using social media data.

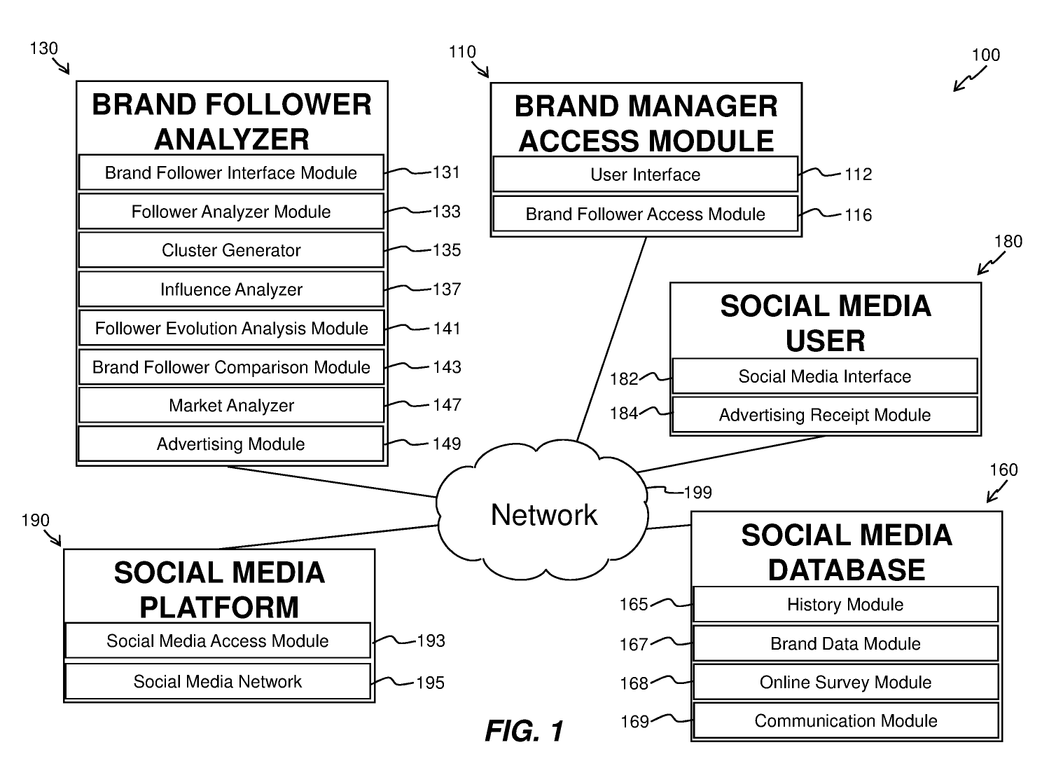

FIG. 1 is a functional block diagram illustrating an environment 100 for tracking of brand followers and generation of directed advertising using social media data. In an exemplary embodiment, a brand manager, a brand marketer, a sales specialist, an advertiser, or any other individual interested in using social media history to track brand followers utilizes a brand manager access module 110 to access a brand follower analyzer 130. The brand follower analyzer 130 has access to a social media database 160 to obtain the required social media history. The social media database 160 has stored social media history obtained from social media user(s) 180 accessing the social media platform 190 recently, and in the more distant past. Although only one social media user 180 is displayed in FIG. 1, any number of users is contemplated. The brand follower analyzer 130 generates a market analysis in response to access from the brand manager access module 110, and the brand follower analyzer 130 may further generate and transmit directed advertising directly to the social media users 180 based upon the market analysis. Brand manager 110, brand follower analyzer 130, social media database 160, social media user 180, and social media platform 190 are interconnected via network 199.

In various embodiments, network 199 represents, for example, an internet, a local area network (LAN), a wide area network (WAN) such as the Internet, and includes wired, wireless, or fiber optic connections. In general, network 199 may be any combination of connections and protocols that will support communications between brand manager 110, brand follower analyzer 130, social media database 160, social media user 180, and social media platform 190, in accordance with an embodiment of the invention.

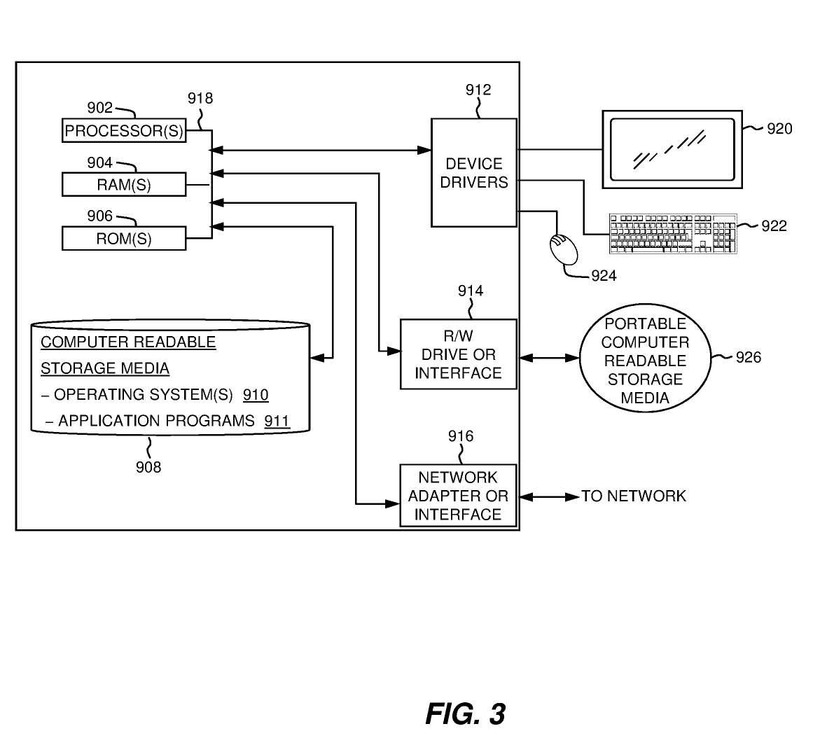

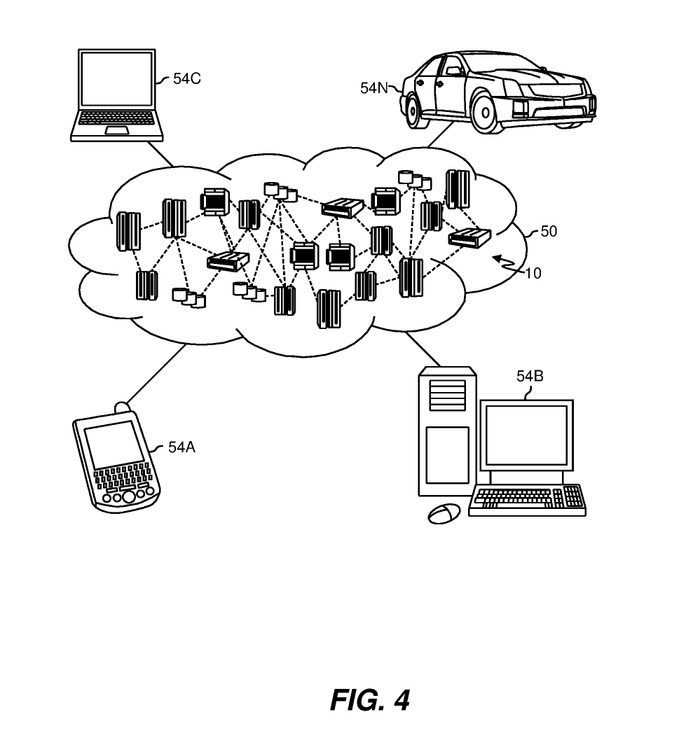

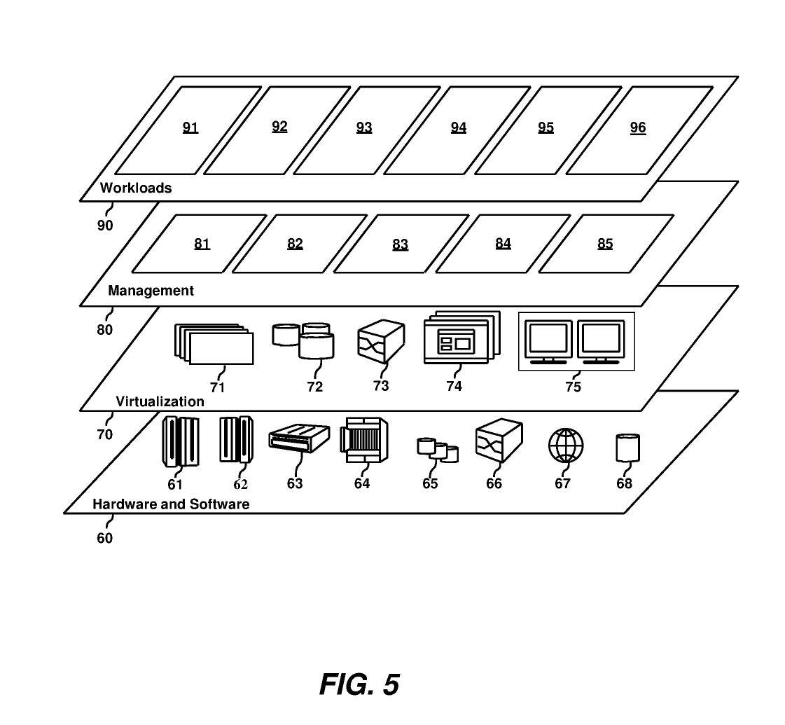

In various embodiments, brand manager access module 110, brand follower analyzer 130, social media database 160, social media user 180, and social media platform 190 may be, for example, a mainframe or a mini computer, a terminal, a laptop, a tablet, a netbook personal computer (PC), a mobile device, a desktop computer, or any other sort of computing device, in accordance with embodiments described herein. Brand manager access module 110, brand follower analyzer 130, social media database 160, social media user 180, and social media platform 190 may include internal and external hardware components as depicted and described further in detail with reference to FIG. 3, below. In other embodiments, each of brand manager access module 110, brand follower analyzer 130, social media database 160, social media user 180, and social media platform 190 may be implemented in a cloud computing environment, as described in relation to FIGS. 4 and 5, below. In a still further embodiment, some or all of brand manager access module 110, brand follower analyzer 130, social media database 160, social media user 180, and social media platform 190 are embodied in physically the same computing device, with all communications between various components internally.

Brand manager access module 110, brand follower analyzer 130, social media database 160, social media user 180, and social media platform 190, represent a computing device possessing sufficient processing power to execute software tracking brand followers using social media history. Computing devices associated with manager access module 110, brand follower analyzer 130, social media database 160, social media user 180, and social media platform 190, in tracking brand followers, utilize a hosted workload 96 as displayed in connection with FIG. 5 below, and/or perform other tasks as further described herein.

In the exemplary embodiment, the brand manager access module 110 includes a user interface 112 and a brand follower access module 116.

The user interface 112 represents hardware and/or software for a brand manager, a brand marketer, a sales specialist, an advertiser, or any other individual interested in using social media history to obtain a market analysis for any single brand having a brand account on a social media platform, competitor analyses, as well as general market analyses. The user interface 112 may include a display screen 920, a keyboard or keypad 922, and a computer mouse or touchpad 924, as described in connection with FIG. 3, below. As further discussed, the market analysis is generated by the brand follower analyzer 130 based upon various data. After generation by the brand follower analyzer 130, the market analysis is presented to the brand manager, brand marketer, sales specialist, advertiser, or other via the user interface 112. The brand manager, brand marketer, sales specialist, advertiser, or any other individual may also utilize the user interface 112 to request generation of directed advertising to social media users 180. The directed advertising is generated by the brand follower analyzer module 130, as further discussed herein.

Brand follower access module 116 represents hardware and/or software for the brand manager access module 110 to access the brand follower analyzer 130 and request generation of the market analysis, as well as request generation from the brand follower analyzer 130 of directed advertising based upon the market analysis, as further discussed. The hardware portions of the brand follower access module 116 may be, for example, a network adapter or interface 916 such as discussed in connection with FIG. 3, below.

In the exemplary embodiment, the brand follower analyzer 130 includes a brand follower interface module 131, a follower analyzer module 133, a cluster generator 135, an influence analyzer 137, a follower evolution analysis module 141, a brand follower comparison module 143, a market analyzer 147, and an advertising module 147.

Brand follower interface module 131 represents hardware and/or software for brand follower analyzer 130 to transmit and receive data via the network 199 from the brand manager access module 110, the social media database 160, the social media user 180, and social media platform 190. The hardware portions of the brand follower interface module 131 may be, for example, a network adapter or interface 916 such as discussed in connection with FIG. 3, below. In the context of transmitting and receiving data, the brand follower interface module 131 performs several functions as further discussed below.

The brand follower interface module 131 receives requests for market analysis from the brand manager access module 110. The market analysis is for a specific brand having a brand account on a social media platform. The market analysis provides various demographic and other information regarding customers or potential customers, the market for similar products as a whole, as well as other data as further discussed below. To generate the market analysis for transmission to the brand manager access module 110, the brand follower analyzer 130 relies upon various data received via brand follower interface module 131 from the social media database 160. The brand follower interface module 131 of brand follower analyzer 130 receives social media habits of social media users 180 as well as, optionally, online survey results obtained from social media users 180. The social media habits of social media users 180 notes usage of the social media platform by each social media user 180 including products, interests, people social media users 180 have “liked,” data feeds each social media user 180 has followed, products each social media user 180 has posted, and otherwise as further described herein. The brand follower interface module 131 may receive specific brand data regarding one or more brands having brand accounts on the social media platform 190. The brand follower interface module 131 may also receive a plurality of historical follower profiles for the followers of brand accounts on the social media platform 190. Finally, the brand follower interface module 131 may receive a second brand having a second brand account on the social media platform 190. The second brand is received for comparison with the first brand. All data received by the brand follower interface module 131 is utilized as further discussed.

The brand follower interface module 131 transmits completed market analyses, after generation by the brand follower analyzer 130, as further discussed, to the brand manager access module 110 as well as transmits directed advertising to the social media user 180 after generation, also as further discussed.

Follower analyzer module 133 represents software for utilizing data received by the brand follower interface module 131 for determining a distribution of brand followers among social media user(s) 180. The distribution of brand followers is based upon the received social media habits of social media user(s) 180 and, optionally, online survey results received by the brand follower interface module 131 from the social media database 160. The social media habits are regarding social media user(s) 180 recent and/or historical social media habits as the social media users 180 browse the social media platform 190. As social media users 180 visit various social media pages, “like” products, interests, people, etc., follow data feeds, and post his or her own photos, articles, products, etc. the social media habits are noted by the social media platform 190 and stored for later use in the social media database 160. The distribution of brand followers may be determined in various ways, such as based upon all social media users 180 who “like” a brand as well as other social media habits of these social media users, or in other ways.

The optional online survey results received by the follower analyzer module 133 indicate, by means of non-limiting example, social media users' 180, gender, age, geographic distribution, income, occupation, hobbies, interests, favorite brands, sports teams of interest, etc. Each individual data point of the online survey results (or some combination of them) may be of specific interest in analyzing brand followers, providing, for example, a gender or age to target marketing to, a geographic area to target, hobbies to market products for, sports memorabilia, etc.

The distribution of brand followers determined by the brand follower analyzer module 133 is utilized for generation of clusters, as further discussed herein, and in other ways. The distribution of brand followers may also be of direct interest to the social media user 180, for marketing, advertising, improved product selection, etc. Personality assessment software may be further utilized by the brand follower analyzer 130 to further analyze social media habits and the online survey results, or in determining a distribution of brand followers.

Cluster generator 135 represents software using a clustering algorithm for generation of one or more clusters for viewing market segmentation, such as for a certain brand for analysis. The one or more clusters may be directly utilized by the user, or may be used by the presently disclosed invention as an interim step in generation of other analysis or of directed advertising. The one or more clusters may be generated via usage of the social media habits and/or the online survey results received from via the brand follower interface module 131 from the social media database 160. The clusters allow for easy visualization of market segmentation regarding the brand for analysis, and may display various attributes for the social media users, various interests, etc. The clusters may utilize generalized clustering techniques with multivariate data described herein. The clusters may be customizable by the brand manager access module 110 to be directed towards certain attributes (such as, for example, all social media users of a certain age, gender, occupation, or by any other attribute or combination of attributes), customized analysis for users of a certain brand, or a competing brand, or customized in other ways. For example, a car company representative utilizing brand manager access module 110 may desire to see how social media users 180 are grouped into different clusters generally in order to better tailor his or her own marketing plans for future car models, whereas a clothing company representative may desire to see how brand followers are clustered according to certain attributes, such as geographic location, and income in order to decide where to build a new retail store. In an embodiment of the invention, the clusters may also be grouped according to user personality, the user personality obtained via software methods allowing for analysis of personalities for each social media user.

Influence analyzer 137 represents software for generating an influencer analysis for a plurality of brand accounts. The influencer analysis detects which brand followers have a highest level of influence among all brand followers and are, for example, early adopters of brands while other brand followers lag behind. Brand followers having the highest level of influence may be, for example, celebrities, politicians, public figures, or otherwise. The influencer analysis may be directly utilized by the brand manager, brand marketer, sales specialist, or any other individual utilizing brand manager access module 110 in developing specific marketing strategies, advertising strategies, marketing/advertising campaigns, etc., and as otherwise described herein. As discussed above in connection with the brand follower interface module 131, the brand follower interface module 131 receives from the social media database 160 specific brand data regarding the plurality of brands having brand accounts, historical follower profiles for brand followers of the brands having brand accounts, social media information for the followers of the plurality of brand accounts, and social media information for the followers of the plurality of brand accounts. In generating the influencer analysis, the influence analyzer 137 may use weighted metrics such as a number of followers for a brand account, or whether a follower of a brand account is a celebrity in a related field. The influence analyzer 137 generates the influencer analysis based upon any or all of the plurality of brand accounts, brand data regarding the plurality of brands having brand accounts, historical follower profiles, and social media information for the followers of the plurality of brand accounts.

Follower evolution analysis module 141 represents software for generation of a historical distribution analysis for each historical follower profile for a plurality of periods according to a periodic basis. The historical distribution analysis may be utilized by the brand manager, brand marketer, sales specialist, or any other individual utilizing brand manager access module 110 in looking at historical data to see trends, leading to intelligent decision making for the future, and as otherwise described herein, specifically in generation of directed advertising. As discussed previously, the brand follower analyzer 110 receives historical follower profiles for brand followers. The historical follower profiles are tracked according to a periodic basis. The periodic basis may be one day, three days, one week, one month, three months, six months, one year, or any other time frame. The follower evolution analysis module 141 generates a historical distribution for each historical follower profile for each period according to the periodic basis. The follower evolution analysis module 141 may also provide the historical distribution at any snapshot in time for which data is available. Multiple historical distributions may be utilized to, for example, indicate changes in demographics of brand followers, to provide useful insight for brand manager, brand marketer, sales specialist, or any other individual utilizing brand manager access module 110.

Brand follower comparison module 143 represents software for generation of a direct comparison of brand followers among two or more brands having brand accounts on the social media platform 190. The brand follower comparison module 143 may be utilized to provide insights about whether two competitor brands have similar age distribution of potential customers according to information available on social media. A visual comparison such a via side-by-side graphs is also contemplated. If the brand manager, brand marketer, sales specialist, or any other individual utilizing brand manager access module 110 desires a competitor analysis, a second, third, or subsequent brand for analysis is sent for competitor analysis to the brand follower interface module 131. In order to generate the analysis, all brands considered have a social media account on the social media platform 190. The brand follower comparison module 143, in response, generates a second (or subsequent) distribution of second brand followers for social media user(s) 180, based upon the received social media habits of social media users 180 and, optionally, online survey results received by the brand follower interface module 131, from the social media database 160.

Market analyzer 147 represents software for generating a market analysis for the brand manager, brand marketer, sales specialist, or any other individual utilizing brand manager access module 110 upon request. The market analysis may include an analysis of demographic information regarding demographics of the social media users following a brand account, other brands the social media users follow, further information regarding the other brands such as corporate information, revenue, product line, etc. as well as other data. In generating the market analysis, the market analyzer 147 may rely upon any of the distribution of brand followers determined by the follower analyzer module 133, clusters generated by the cluster generator 135, the influencer analysis generated by the influence analyzer 137, the historical distribution analysis generated by the follower evolution analysis module 141, and any direct comparison of brand followers generated by the follower evolution analysis module 141. Advertising module 149 represents software for automatically generating directed advertising for transmission to social media user(s) 180. The directed advertising is generated based upon market analysis previously generated by the market analyzer 147, and is specifically directed at social media user(s) 180 based upon for example, the interests, demographic information, previous purchases, browsing history, etc. such as displayed by the market analysis. Directed advertising is contemplated to be viewable by each social media user 180 directly within the social media platform 190, as further discussed, and is displayed in real-time immediately after generation. The advertising module 149 may alternatively generate targeted e-mails for distribution to the e-mail accounts of social media user(s), the e-mails including the directed advertising.

In the exemplary embodiment, the social media database 160 includes history module 165, brand data module 167, online survey module 168, and communication module 169.

History module 165 represent software and/or hardware for storing various historical data utilized in the presently disclosed invention, as further described. The history module 165 may store data regarding social media habits of social media user(s) 180. As social media user(s) 180 visit social media pages available via the social media platform 190, “like” products, interests, people, etc., follow data feeds, and post his or her own photos, articles, products, etc., the history module 165 of the social media database 160 stores the data regarding social media habits.

Brand data module 167 represents software and/or hardware for storing brand data regarding a plurality of brands having brand accounts on the social media platform 190. Brand data may include information regarding identities of brand followers, celebrity brand followers, numbers of brand followers across different timeframes, brand competitors (having a social media account or otherwise), corporate data, products sold at various times, types of products at various times, brand personality, brand follower personality, etc. The brand personality and brand follower personality may be determined utilizing machine learning metrics. Brand data module 167 may also store historical follower profiles regarding brand followers at various snapshots in time, such as the number of historical brand followers, demographic information regarding these brand followers, etc.

Online survey module 168 represents software for storing online survey results obtained from social media user(s) 180. Online survey results may indicate age, occupation, income, hobbies, preferred brands, gender, interests, geographic location, etc. In obtaining the online survey results, social media user(s) 180 are presented with online surveys directly from the social media platform 190, via e-mail, or in any other way. Online survey results are stored for later use as described.

Communication module 169 represents software for transmitting data stored in the social media database 160 as required, and further discussed herein.

In the exemplary embodiment, social media user 180 includes a social media interface 182 and an advertising receipt module 184.

Social media interface 182 represents software and/or hardware for a social media user to access social media platform 190. Social media interface 182 may also be utilized by social media database 190 and social media platform 160

Advertising receipt module 184 represents software for receipt of directed advertising from the brand follower analyzer 130. After generation of directed advertising by the advertising module 149, the advertising receipt module 184 receives the advertising and displays it such as in a monitor 920, as shown in FIG. 3 associated with the social media user 180.

In the exemplary embodiment, the social media platform 190 includes a social media access module 193 and a social media network 195.

Social media access module 194 represents software and/or hardware for access of a social media network 195 by social media user 180.

Social media network 195 may be any presently existing or after-arising social media network.

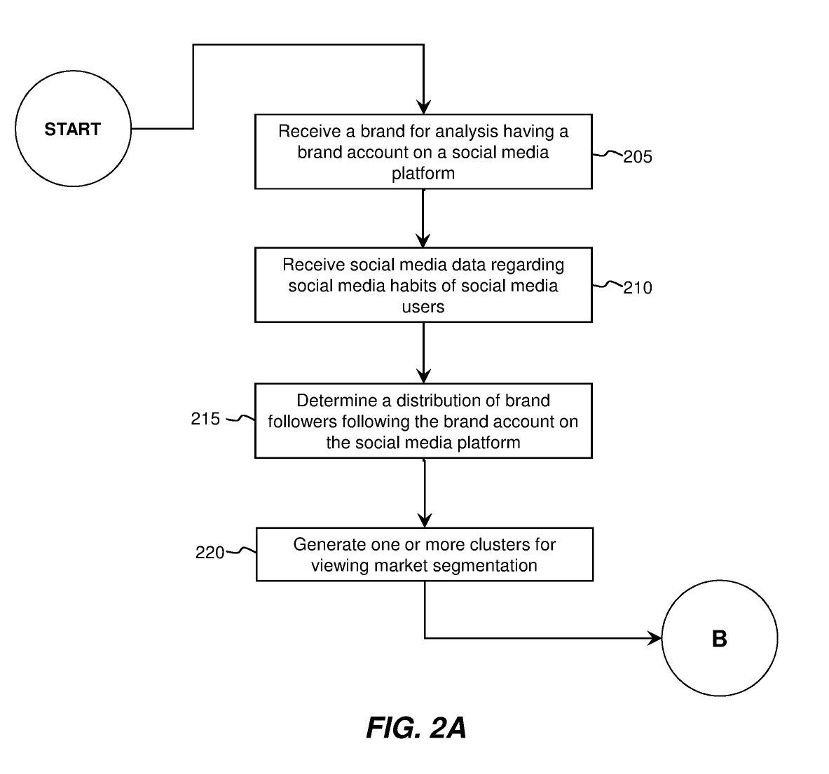

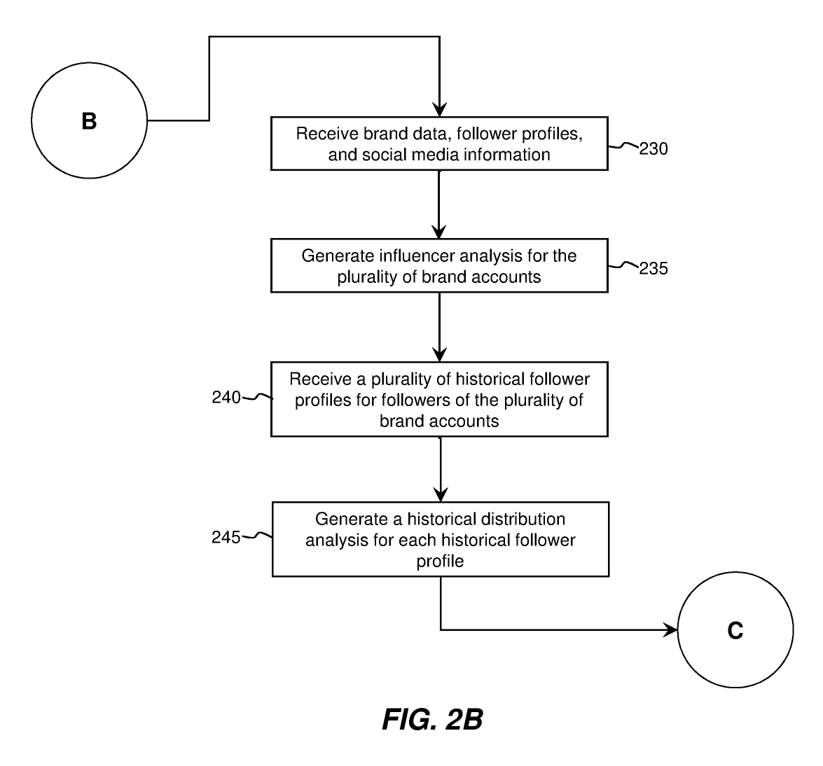

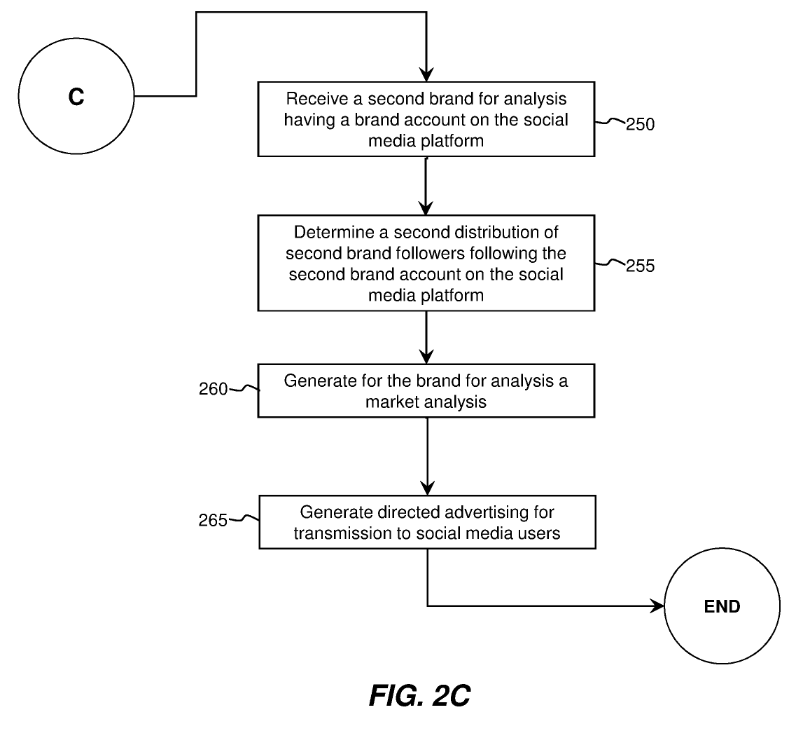

FIGS. 2A, 2B, and 2C are a flowchart depicting operational steps that a hardware component, multiple hardware components, and/or a hardware appliance may execute, in accordance with an embodiment of the invention. At step 205, brand follower interface module 131 of brand follower analyzer 130 receives a brand for market analysis, the brand having a brand account on the social media platform 190. At step 210, social media history regarding social media habits of social media users 180 obtained from the social media users 180 are received by the brand follower interface module 131 of the brand follower analyzer 130 from the social media database 160. Optionally, online survey results obtained from the social media users 180 are received by the brand follower interface module 131 as well. At step 215, follower analyzer module 133 of the brand follower analyzer 130 determines a distribution of brand followers among social media users 180 following the brand account on the social media platform 190, based upon the social media habits of social media users 180 from the social media users 180. Optionally, the follower analyzer module 133 utilizes the social media habits of social media users 180 in conjunction with online survey results in determining a distribution of brand followers. At step 220, cluster generator 135 of the brand follower analyzer 130 generates one or more clusters for viewing market segmentation regarding the brand for market analysis, the one or more clusters generated via utilization of the social media habits of the social media users 180 from social media users 180. The cluster generator 135 may also use online survey results in generating the one or more clusters.

At step 230 the brand follower interface module 131 of the brand follower analyzer 130 receives from the social media database 160 brand data regarding a plurality of brands having brand accounts on the social media platform 190, follower profiles for brand followers of the plurality of brand accounts, and social media information for the followers of the plurality of brand accounts. At step 235, the influence analyzer 137 generates an influencer analysis for the plurality of brand accounts, the influencer analysis based upon the brand data regarding the plurality of brands, follower profiles, and the social media information for the followers of the plurality of brand accounts. At step 240, the brand follower interface module 131 receives from the social media database 160 a plurality of historical follower profiles for followers of the plurality of brand accounts. At step 245, follower evolution analysis module 141 generates a historical distribution analysis of each historical follower profile for a plurality of periods according to the periodic basis.

At step 250 the brand follower interface module 131 receives a second brand for market analysis, the second brand for market analysis having a second brand account on the social media platform 190. At step 255, brand follower comparison module determines a second distribution of second brand followers for social media users 180 following the second brand account on the social media platform 190 based upon the social media habits of social media users 180 obtained from social media users 180. Optionally, the brand follower interface module 131 also receives online survey results obtained from social media users 180. At step 260, the market analyzer 147 generates for the brand for market analysis a market analysis utilizing the distribution of brand followers determined by the follower analyzer module 133, the one or more clusters for viewing market segmentation generated by the cluster generator 135, the influencer analysis generated by the influence analyzer 137, the historical distribution analysis generated by the follower evolution analysis module 141, and/or the second distribution of second brand followers generated by the brand follower comparison module 143. At step 265, the advertising module 149 generates directed advertising for transmission to the social media users 180 based upon the market analysis.

FIG. 3 depicts a block diagram of components of brand manager access module 110, brand follower analyzer 130, social media database 160, social media user 180, and social media platform 190 in the environment 100 for tracking of brand followers and generation of directed advertising using social media history, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Brand manager access module 110, brand follower analyzer 130, social media database 160, social media user 180, and social media platform 190 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, the environment 100 for tracking of brand followers and generation of directed advertising using social media history, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Brand manager access module 110, brand follower analyzer 130, social media database 160, social media user 180, and social media platform 190 may also include a R/W drive or interface 914 to read from and write to one or more portable computer readable storage media 926. Application programs 911 on brand manager access module 110, brand follower analyzer 130, social media database 160, social media user 180, and social media platform 190 may be stored on one or more of the portable computer readable storage media 926, read via the respective R/W drive or interface 914 and loaded into the respective computer readable storage media 908.

Brand manager access module 110, brand follower analyzer 130, social media database 160, social media user 180, and social media platform 190 may also include a network adapter or interface 916, such as a TCP/IP adapter card or wireless communication adapter (such as a 4G wireless communication adapter using OFDMA technology). Application programs 911 on brand manager access module 110, brand follower analyzer 130, social media database 160, social media user 180, and social media platform 190 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Brand manager access module 110, brand follower analyzer 130, social media database 160, social media user 180, and social media platform 190 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a method, computer program product, and/or computer system at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, computer program products, and apparatus (systems) according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are executed by the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of method, system, and computer program product according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the environment 100 for tracking of brand followers and generation of directed advertising using social media data.

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method of tracking brand followers utilizing social media history and generating directed advertising, the method comprising:
receiving by a computing device a brand for market analysis, the brand having a brand account on a social media platform;
receiving by the computing device social media history regarding social media habits of social media users of the social media platform obtained from the social media users;
determining by the computing device a distribution of brand followers among social media users following the brand account on the social media platform based upon the social media habits of social media users from the social media users;
generating by the computing device one or more clusters for viewing market segmentation regarding the brand for market analysis, the one or more clusters generated by utilization of the social media habits of social media users from social media users;
receiving by the computing device brand data regarding a plurality of brands having brand accounts on the social media platform, follower profiles for brand followers of the plurality of brand accounts, and social media information for the followers of the plurality of brand accounts; and
generating by the computing device an influencer analysis for the plurality of brand accounts, the influencer analysis based upon the brand data regarding the plurality of brands, follower profiles, and the social media information for the followers of the plurality of brand accounts.

2. The method of claim 1, further comprising:
receiving by the computing device a plurality of historical follower profiles for followers of the plurality of brand accounts, the historical follower profiles tracked according to a periodic basis; and
generating a historical distribution analysis of each historical follower profile for a plurality of periods according to the periodic basis.

3. The method of claim 2 further comprising:
receiving by the computing device a second brand for market analysis, the second brand for market analysis having a second brand account on the social media platform; and
determining by the computing device a second distribution of second brand followers for social media users following the second brand account on the social media platform based upon the social media habits of social media users from social media users.

4. The method of claim 3, further comprising:
generating for the brand for market analysis, a market analysis utilizing selectively one or more of the following: the distribution of brand followers, the one or more clusters for viewing market segmentation, the influencer analysis, the historical distribution analysis, and the second distribution of second brand followers.

5. The method of claim 4, further comprising generating directed advertising for transmission to the social media users based upon the market analysis.

6. The method of claim 1, further comprising receiving online survey results obtained from the social media users, and when determining a distribution of brand followers among social media users and generating one or more clusters for viewing market segmentation regarding the brand for analysis, further basing the distribution of brand followers based upon the online survey results and further generating the one or more clusters utilizing the online survey results.

7. The method of claim 6, wherein the online survey results indicate selectively one or more of the following regarding each follower of the social media platform: a gender, an age, a geographic location, and an income.

8. The method of claim 1, further comprising when generating by the computing device the one or more clusters, further utilizing brand personality of the brand for market analysis and follower personality for each social media user to generate the one or more clusters.

9. A computer program product for tracking brand followers using social media history and generated directed advertising, the computer program product comprising:
one or more non-transitory computer-readable storage media and program instructions stored on the one or more non-transitory computer-readable storage media, the program instructions, when executed by the computing device, cause the computing device to perform a method comprising:
receiving by a computing device a brand for market analysis, the brand having a brand account on a social media platform;
receiving by the computing device social media history regarding social media habits of social media users of the social media platform obtained from the social media users;
determining by the computing device a distribution of brand followers among social media users following the brand account on the social media platform based upon the social media habits of social media users from the social media users;
generating by the computing device one or more clusters for viewing market segmentation regarding the brand for market analysis, the one or more clusters generated by utilization of the social media habits of social media users from social media users;
receiving by the computing device brand data regarding a plurality of brands having brand accounts on the social media platform, follower profiles for brand followers of the plurality of brand accounts, and social media information for the followers of the plurality of brand accounts; and
generating by the computing device an influencer analysis for the plurality of brand accounts, the influencer analysis based upon the brand data regarding the plurality of brands, follower profiles, and the social media information for the followers of the plurality of brand accounts.

10. The computer program product of claim 9, wherein the method performed by the computing device further comprises:
receiving by the computing device a plurality of historical follower profiles for followers of the plurality of brand accounts, the historical follower profiles tracked according to a periodic basis; and
generating a historical distribution analysis of each historical follower profile for a plurality of periods according to the periodic basis.

11. The computer program product of claim 10, wherein the method performed by the computing device further comprises:
receiving by the computing device a second brand for market analysis, the second brand for market analysis having a second brand account on the social media platform; and
determining by the computing device a second distribution of second brand followers for social media users following the second brand account on the social media platform based upon the social media habits of social media users from social media users.

12. The computer program product of claim 11, wherein the method performed by the computing device further comprises:
generating for the brand for market analysis, a market analysis utilizing selectively one or more of the following: the distribution of brand followers, the one or more clusters for viewing market segmentation, the influencer analysis, the historical distribution analysis, and the second distribution of second brand followers.

13. The computer program product of claim 12, wherein the method performed by the computing device further comprises:
generating directed advertising for transmission to the social media users based upon the market analysis.

14. The computer program product of claim 9, wherein the method performed by the computing device further comprises receiving online survey results obtained from the social media users, and when determining a distribution of brand followers among social media users and generating one or more clusters for viewing market segmentation regarding the brand for analysis, further basing the distribution of brand followers based upon the online survey results and further generating the one or more clusters utilizing the online survey results.

15. The computer program product of claim 14, wherein the online survey results indicate selectively one or more of the following regarding each follower of the social media platform: a gender, an age, a geographic location, and an income.

16. The computer program product of claim 9, wherein the method performed by the computing device further comprises when generating by the computing device the one or more clusters, further utilizing brand personality of the brand for market analysis and follower personality for each social media user to generate the one or more clusters.

17. A computer system for tracking brand followers using social media history and generated directed advertising, the computer system comprising:
one or more computer processors;
one or more computer-readable storage media;
program instructions stored on the computer-readable storage media for execution by at least one of the one or more processors, the program instructions comprising:
program instructions to receive by a computing device a brand for market analysis, the brand having a brand account on a social media platform;
program instructions to receive by the computing device social media history regarding social media habits of social media users of the social media platform obtained from the social media users;
program instructions to determine by the computing device a distribution of brand followers among social media users following the brand account on the social media platform based upon the social media habits of social media users from the social media users;
program instructions to generate by the computing device one or more clusters for viewing market segmentation regarding the brand for market analysis, the one or more clusters generated by utilization of the social media habits of social media users from social media users;
program instructions to receive by the computing device brand data regarding a plurality of brands having brand accounts on the social media platform, follower profiles for brand followers of the plurality of brand accounts, and social media information for the followers of the plurality of brand accounts; and
program instructions to generate by the computing device an influencer analysis for the plurality of brand accounts, the influencer analysis based upon the brand data regarding the plurality of brands, follower profiles, and the social media information for the followers of the plurality of brand accounts.

18. The computer system of claim 17, wherein the program instructions further comprise:
program instructions to receive by the computing device a plurality of historical follower profiles for followers of the plurality of brand accounts, the historical follower profiles tracked according to a periodic basis;
program instructions to generate a historical distribution analysis of each historical follower profile for a plurality of periods according to the periodic basis;
program instructions to receive by the computing device a second brand for market analysis, the second brand for market analysis having a second brand account on the social media platform; and
program instructions to determine by the computing device a second distribution of second brand followers for social media users following the second brand account on the social media platform based upon the social media habits of social media users from social media users.

19. The computer system of claim 18, wherein the program instructions further comprise program instructions to generate for the brand for market analysis, a market analysis utilizing selectively one or more of the following: the distribution of brand followers, the one or more clusters for viewing market segmentation, the influencer analysis, the historical distribution analysis, and the second distribution of second brand followers.

20. The computer system of claim 19, wherein the program instructions further comprise program instructions to generate directed advertising for transmission to the social media users based upon the market analysis.
